(19) United States
(12) Patent Application Publication
(10) Pub. No.: US 2026/0208482 A1
(43) Pub. Date: Jul. 23, 2026

(54) IMAGE FORMING DEVICE

(71) Applicant: SEIKO EPSON CORPORATION, TOKYO (JP)

(72) Inventors: Shingo WAKI, MATSUMOTO-SHI (JP); Akira NAKAZAWA, AZUMINO-SHI (JP); Takao OIZUMI, MATSUMOTO-SHI (JP); Hiroki CHINO, MATSUMOTO-SHI (JP)

(21) Appl. No.: 19/452,968

(22) Filed: Jan. 20, 2026

(30) Foreign Application Priority Data
Jan. 20, 2025 (JP) 2025-007569

(51) Int. Cl. B41J 2/045; B41J 2/165; B41J 2/17; B41J 11/00; B41J 19/00; B41J 29/38

(52) U.S. Cl. CPC B41J 2/04551; B41J 2/16505; B41J 2/1721; B41J 11/007; B41J 19/005; B41J 29/38; B41J 2/04586

(57) ABSTRACT

The image forming device 1 according to the present disclosure includes a reception section 20 that receives information related to disasters, an image forming section 6 that executes an image forming process on a medium 7, and a control section 21. The control section 21 includes a first control mode 211 that causes one or more component sections to execute an operation for normal use and a second control mode 212 that executes an operation for protecting the one or more component sections. The control section 21 switches from the first control mode 211 to the second control mode 212 when the reception section 20 receives the information.

The present application is based on, and claims priority from JP Application Serial Number 2025-007569, filed January 20, 2025, the disclosure of which is hereby incorporated by reference herein in its entirety.

### BACKGROUND

### Technical Field

The present disclosure relates to an image forming device.

### Related Art

An example of the related art device of this kind is described in JP-A-2009-230436.

JP-A-2009-230436 disclose an image forming device (laser printer or the like) that stops a printing operation when disaster information is received.

However, the image forming device does not include a way to protect components of the image forming device when disaster information is received. For example, in a case of an inkjet printer, in a state where the printing operation is stopped, a head is left in a state of being exposed to air. In this case, moisture evaporation from a nozzle of the head proceeds, the viscosity of ink increases, and nozzle clogging occurs, which can lead to a cause of failure and make recovery difficult. It is necessary to suppress a nozzle surface of the head from coming into contact with other parts due to vibration of an earthquake or the like, but this is not considered.

### SUMMARY

An image forming device according to the present disclosure for overcoming the above-described problem includes a reception section that receives information related to disasters; an image forming section that executes an image forming process on a medium; and a control section, wherein the control section includes a first control mode that causes one or more component sections to execute an operation for normal use and a second control mode that executes an operation for protecting the one or more component sections and the control section switches from the first control mode to the second control mode when the reception section receives the information.

### BRIEF DESCRIPTION OF THE DRAWINGS

FIG. 1 is a schematic perspective view of an image forming device according to a first embodiment.

FIG. 2 is a schematic diagram of a main configuration of a recording device according to the first embodiment.

FIG. 3 is a schematic diagram of a main configuration of the recording device according to the first embodiment.

FIG. 4 is a flowchart illustrating a control flow of a second control mode according to the first embodiment.

FIG. 5 is a flowchart illustrating a control flow of the second control mode according to the first embodiment.

FIG. 6 is an explanatory diagram of movement of a movement section according to a second embodiment.

FIG. 7 is an explanatory diagram of movement of an endless belt according to a third embodiment.

FIG. 8 is a flowchart illustrating a control flow of a control section according to a fourth embodiment.

### DESCRIPTION OF EMBODIMENTS

Hereinafter, the present disclosure will be schematically described.

An image forming device according to a first aspect of the present disclosure for overcoming the above-described problem includes a reception section that receives information related to disasters; an image forming section that executes an image forming process on a medium; and a control section, wherein the control section includes a first control mode that causes one or more component sections to execute an operation for normal use and a second control mode that executes an operation for protecting the one or more component sections and the control section switches from the first control mode to the second control mode when the reception section receives the information.

According to the present aspect, the control section includes a first control mode that causes one or more component sections to execute an operation for normal use and a second control mode that executes an operation for protecting the one or more component sections and the control section switches from the first control mode to the second control mode when the reception section receives the information. By this, component sections such as the image forming section can be actively protected in addition to simply stopping a printing operation as in the related art.

An image forming device according to a second aspect of the present disclosure is an aspect according to the first aspect, wherein the image forming section includes a head configured to eject ink from a nozzle toward the medium and a cap that covers a nozzle surface of the head and in the second control mode, an operation of covering the nozzle surface with the cap is executed.

According to the present aspect, the image forming section includes a head configured to eject ink from a nozzle toward the medium and a cap that covers a nozzle surface of the head and, in the second control mode, an operation of covering the nozzle surface with the cap is executed. This makes it possible to suppress evaporation of moisture from the nozzles of the head that ejects ink, and to suppress occurrence of failure caused by the moisture evaporation. Therefore, a normal use state can be easily restored thereafter.

An image forming device according to a third aspect of the present disclosure is an aspect according to the second aspect, wherein the image forming device further includes a waste liquid accommodation section that receives and accommodates ink in the cap, wherein in the second control mode, in a case where the nozzle is being cleaned in a state where the nozzle surface is covered with the cap, the ink in the cap is discharged to the waste liquid accommodation section.

According to the present aspect, in the second control mode, in a case where the nozzle is being cleaned in a state where the nozzle surface is covered with the cap, the ink in the cap is discharged to the waste liquid accommodation section. This can suppress ink leakage during cleaning.

An image forming device according to a fourth aspect of the present disclosure is an aspect according to the first aspect, wherein the image forming device further includes a movement section that reciprocates in a state of being connected to a flexible flat cable (FFC), wherein the movement section includes a first stop position that is a stop position in the first control mode and a second stop position that is different from the first stop position, the second stop position is a position where a degree of U-shaped curvature of the FFC is looser than that at the first stop position, and in the second control mode, the movement section is positioned at the second stop position.

Note that the present aspect may be according to the second aspect or the third aspect.

The FFC is curved and inverted in a U-shape, and the degree of the U-shape curvature varies depending on a position of the movement section during reciprocating movement. That is, there are a state where the degree of the U-shaped curvature is large and a state where the degree of the U-shaped curvature is small. When a U-shaped curved portion is left for a long time in a state where the degree of the U-shaped curvature is large, the U-shaped curved portion may be deformed.

According to the present aspect, the movement section includes a first stop position that is a stop position in the first control mode and a second stop position that is different from the first stop position. The second stop position is a position where a degree of U-shaped curvature of the FFC is looser than that at the first stop position. In the second control mode, the movement section is positioned at the second stop position. This can suppress the U-shaped curved portion of the FFC from being deformed. Accordingly, it is possible to suppress an adverse effect on a reciprocating operation of the movement section.

An image forming device according to a fifth aspect of the present disclosure is an aspect according to the first aspect, wherein the image forming device further includes a belt unit that transports the medium, wherein the belt unit includes a first roller, a second roller, and an endless belt stretched between the first roller and the second roller, the image forming device further includes a tension applying mechanism that applies a tension to the endless belt, the tension applying mechanism is configured to switch between and apply a first tension that is a tension under the first control mode and a second tension that is a tension smaller than the first tension, and in the second control mode, the second tension is applied to the endless belt.

Note that the present aspect may be according to any one of the second aspect to the fourth aspect.

Since the endless belt is stretched between the first roller and the second roller, when the endless belt is left for a long time in a state where the first tension is applied, a portion in contact with the first roller and a portion in contact with the second roller may become deformed.

According to the present aspect, the tension applying mechanism is configured to switch between and apply a first tension that is a tension under the first control mode and a second tension that is a tension smaller than the first tension. In the second control mode, the second tension is applied to the endless belt. This makes it possible to suppress the occurrence of deformation of the endless belt. Accordingly, it is possible to suppress a decrease in the transport accuracy of the medium due to the deformation.

An image forming device according to a sixth aspect of the present disclosure is an aspect according to the first aspect, wherein in the second control mode, when the information is received, a recording process of the information and information related to the one or more component sections is executed.

Here, the "recording process" in "a recording process of the information and information related to the one or more component sections is executed" is used in a meaning including both a process of printing the information on the medium and a process of storing the information in a storage section.

Note that the present aspect may be according to any one of the second aspect to the fifth aspect.

According to the present aspect, in the second control mode, when the information is received, a recording process of the information and information related to the one or more component sections is executed. By this, the information at the time of disaster can be grasped in the subsequent recovery process, so that appropriate measures can be taken.

An image forming device according to a seventh aspect of the present disclosure is an aspect according to the first aspect, wherein the control section is configured to change an operating state for protecting the component section in accordance with an elapsed time from when the reception section receives the information.

Note that the present aspect may be according to any one of the second aspect to the sixth aspect.

Immediately after the occurrence of a disaster, the necessity of protection for component sections is high. However, the degree of necessity of the protection changes with the lapse of time.

According to the present aspect, the control section is configured to change an operating state for protecting the component section in accordance with an elapsed time from when the reception section receives the information. This makes it possible to implement protection in accordance with a change in situation with the lapse of time of disaster occurrence.

An image forming device according to an eighth aspect of the present disclosure is an aspect according to the first aspect, wherein the image forming device further includes a sensor configured to detect a state (shaking, ambient temperature, ink leakage) of the image forming device, wherein the control section switches from the second control mode to the first control mode based on a detection result of the sensor.

Here, "detect a state of the image forming device" in "a sensor configured to detect a state of the image forming device" means obtaining information useful for a subsequent recovery process of switching from the second control mode to the first control mode.

“Switching from the second control mode to the first control mode" is used to include both switching in one step and switching in a plurality of steps.

Note that the present aspect may be according to any one of the second aspect to the seventh aspect.

According to the present aspect, the image forming device includes a sensor configured to detect a state (shaking, ambient temperature, ink leakage) of the image forming device. The control section switches from the second control mode to the first control mode based on a detection result of the sensor. This makes it possible to effectively perform a subsequent recovery process of switching from the second control mode to the first control mode.

An image forming device according to a ninth aspect of the present disclosure is an aspect according to the first aspect, wherein the image forming device further includes a determination section that determines a shaking state of the image forming device, wherein the control section switches from the first control mode to the second control mode based on a determination result of the determination section.

Here, "determine a shaking state" in "a determination section that determines a shaking state of the image forming device" means distinguishing whether the shaking is caused by an earthquake or the like at the time of disaster or by a simple collision.

Note that the present aspect may be according to any one of the second aspect to the eighth aspect.

According to the present aspect, the image forming device includes a determination section that determines a shaking state of the image forming device. The control section switches from the first control mode to the second control mode based on a determination result of the determination section. By this, if the collision is a mere collision, it is not necessary to protect the device, and therefore, it is possible to avoid an unnecessary protection operation.

### EMBODIMENTS

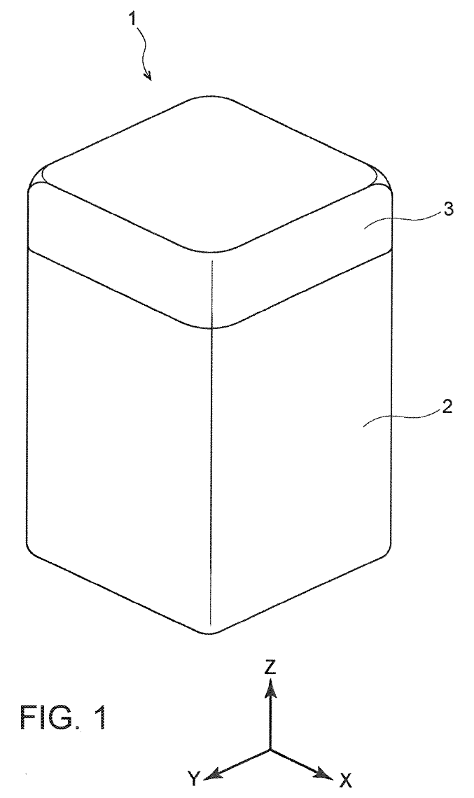

Hereinafter, an image forming device according to an embodiment of the present disclosure will be described in detail with reference to FIGS. 1 to 8.

In the following description, three axes orthogonal to each other are referred to as an X-axis, a Y-axis, and a Z-axis, respectively, as illustrated in each drawing. The direction indicated by arrows of the three axes (X, Y, and Z) is a + direction of each direction, and the opposite direction is a - direction. A Z-axis direction corresponds to a vertical direction, that is, a direction in which gravity acts, a +Z direction indicates a vertically upward direction, and a -Z direction indicates a vertically downward direction. An X-axis direction and a Y-axis direction correspond to horizontal directions. A +Y direction indicates a front direction of the image forming device, and a -Y direction indicates a rear direction of the image forming device. A +X direction indicates a right direction of the image forming device, and a -X direction indicates a left direction of the image forming device.

### EMBODIMENTS

### Overall schematic description of image forming device

An image forming device 1 of the present embodiment is a multifunction device including a recording device 2 such as an inkjet printer as an example and a scanner 3 (FIG. 1).

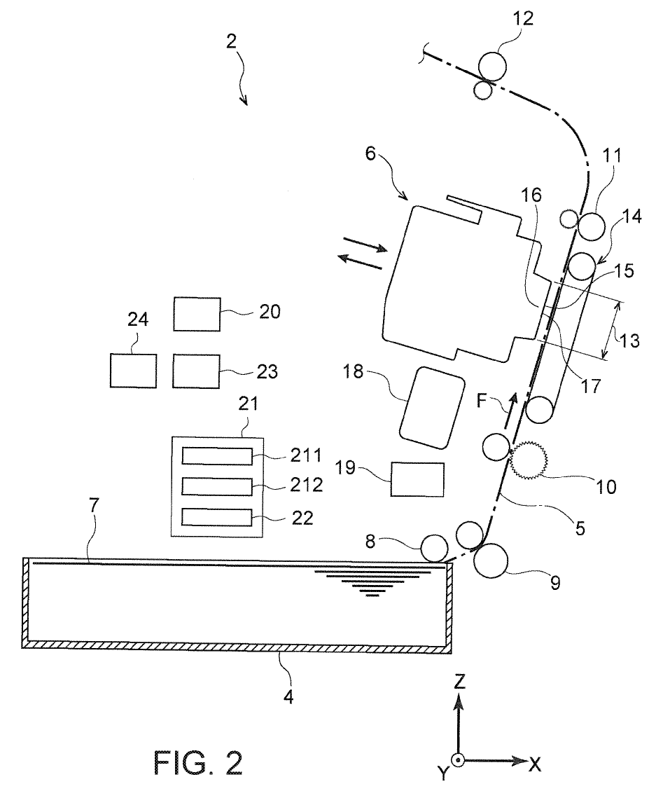

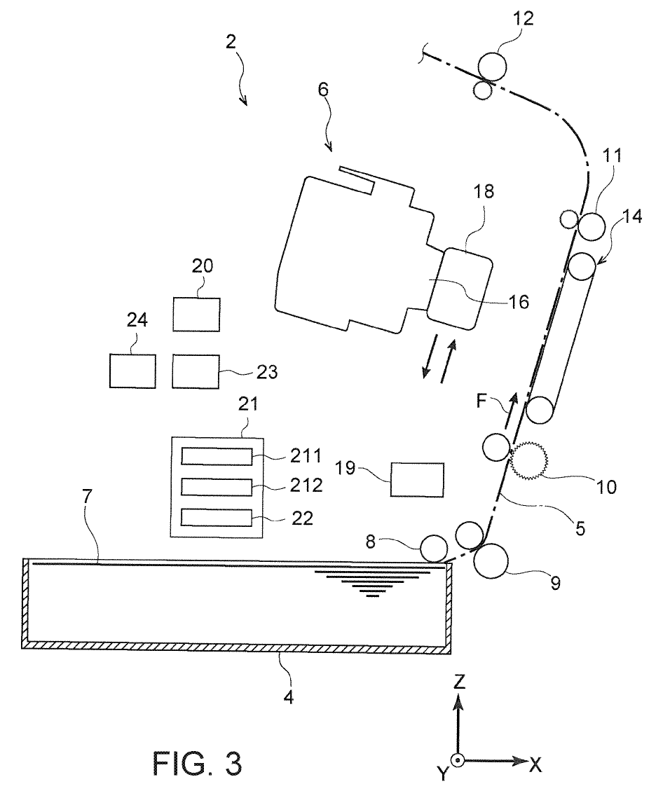

As illustrated in FIGS. 2 and 3, the recording device 2 includes a medium accommodation section 4, a transport path 5, and an image forming section 6. The medium accommodation section 4 accommodates a medium 7 such as paper sheets. The medium 7 is picked up from the medium accommodation section 4 by a pickup roller 8 and fed to the transport path 5.

Transport rollers 9, 10, 11, and 12 that apply a transporting force to the medium 7 are arranged on the transport path 5. An image is formed on the medium 7 transported through the transport path 5 in the image forming region 13 of the image forming section 6. A belt unit 14 is arranged in the image forming region 13.

In the present embodiment, the image forming section 6 includes a head 16 capable of ejecting ink from nozzles 15 toward the medium 7, and a cap 18 that covers a nozzle surface 17 of the head 16. Here, a line head that is long in a width direction (Y-axis direction) of the medium 7 is used as the head 16. The head 16 is displaceable between a printing execution position (position in FIG. 2) at which printing is performed by ejecting ink onto the medium 7 and a maintenance position (position in FIG. 3) at which the nozzle surface 17 is covered with the cap 18. The cap 18 is displaceable between the maintenance position (position in FIG. 3) and a standby position (position in FIG. 2) during printing.

The cap 18 and the waste liquid accommodation section 19 are in communication with each other. The waste liquid accommodation section 19 receives and accommodates ink in the cap 18. The ink in the cap 18 is sent into the waste liquid accommodation section 19 by a liquid sending section such as a pump (not illustrated).

### FIRST EMBODIMENT

First, a configuration of the image forming device 1 according to a first embodiment will be described with reference to FIGS. 1 to 5.

The image forming device 1 according to the present embodiment includes a reception section 20 that receives information related to disasters, the image forming section 6, and a control section 21.

Examples of information related to disasters include information on an earthquake early warning due to J-Alert and information related to a tsunami, a typhoon, heavy rain, a volcano, and the like. Information related to disasters is not limited to information due to J-Alert, and includes information that is determined to be avoided because there is a possibility that a user may interfere with "normal use" (to be described later) if the user continues to use the image forming device 1.

The reception section 20 receives information due to J-Alert or the like via a communication unit such as the Internet. The reception section 20 is configured to be able to receive the information described above based on determination of a user from an operation panel or the like (not illustrated).

The control section 21 causes the transport rollers 9, 10, 11, and 12 and the belt unit 14 to perform a transport operation, and causes the image forming section 6 to perform a printing execution operation on the medium 7. The control section 21 includes a CPU, a flash ROM, and a RAM. The CPU performs various calculation processes in accordance with a program stored in the flash ROM, and controls operation of the entire image forming device 1. The flash ROM, which is an example of a storage unit, is a non-volatile memory that can be read from or written into. Various kinds of information are temporarily stored in the RAM, which is an example of the storage unit.

The control section 21 includes a first control mode 211 and a second control mode 212. The first control mode 211 is a control mode that causes one or more component sections such as the image forming section 6 to execute an operation for normal use. The second control mode 212 is a control mode that executes an operation for protecting the image forming section 6 and the like.

In the case of an inkjet printer, “normal use" is an operation accompanying normal printing in a normal state that is not an emergency such as disaster. Specifically, in a case of the head 16, as illustrated in FIG. 2, ink is ejected onto the medium 7 based on print data to print an image, and when the head 16 is not in use, as illustrated in FIG. 3, the nozzle surface 17 is covered with the cap 18 to prevent ink from drying, and flushing, cleaning of the nozzles 15, and the like are performed.

“Operation for protecting" means that a process of maintaining a state in which the normal use is possible is performed for the component sections such as the head 16, and the details will be described later.

In the present embodiment, the control section 21 is configured to switch from the first control mode 211 to the second control mode 212 when the reception section 20 receives the information.

Specifically, in the second control mode 212, when the reception section 20 receives information related to disasters in the normal use state of FIG. 2, printing is interrupted, and an operation of covering the nozzle surface 17 of the head 16 with the cap 18 is executed to change the state to the state of FIG. 3. That is, the nozzle surface 17 is covered with the cap 18 to be in a state of performing a protection process for preventing ink from drying.

Further, in the present embodiment, the control section 21 is configured to execute an operation of discharging ink in the cap 18 to the waste liquid accommodation section 19 via a liquid sending section (not illustrated) when the nozzles 15 are being cleaned in a state where the nozzle surface 17 is covered with the cap 18 (the state of FIG. 3) in the second control mode 212.

Further, in the present embodiment, the second control mode 212 is configured to execute, when the reception section 20 receives information related to disasters, a recording process 22 of the received information and information related to one or more component sections such as the image forming section 6. The received information includes the date and time of occurrence of the disaster, the scale of the disaster, and the like. The information related to one or more component sections is information related to a state of the image forming section 6 and the like, which are component sections that the image forming device 1 grasps when the reception section 20 receives information related to the disaster. For example, the information includes an error history, an ink remaining amount, a remaining amount of a waste liquid tank, and the like.

Here, the "recording process 22" in “execute a recording process 22 of the received information and information related to one or more component sections such as the image forming section 6" is used in a meaning including both a process of printing the information on the medium 7 and a process of storing the information in a storage section (not illustrated).

Further, in the present embodiment, a determination section 24 that determines a shaking state of the image forming device 1 is provided. The control section 21 is configured to switch from the first control mode 211 to the second control mode 212 based on a determination result of the determination section 24.

Here, "determine a shaking state" in "a determination section 24 that determines a shaking state of the image forming device 1" means distinguishing whether shaking is caused by an earthquake or the like at the time of disaster or shaking is caused by a mere collision. Examples of the determination section 24 include a gyro sensor and an acceleration sensor. The determination section 24 compares a detected waveform with a reference waveform prepared in advance to determine whether a shaking state of the image forming device 1 is due to an earthquake or not. Instead of the reference waveform, artificial intelligence (AI) may be caused to perform data learning to determine whether shaking is due to an earthquake or not.

When the determination result of the determination section 24 is a mere collision, the first control mode 211 is not switched to the second control mode 212. When the determination result of the determination section 24 is that shaking is caused by an earthquake or the like at the time of disaster, the first control mode 211 is switched to the second control mode 212.

Further, in the present embodiment, a sensor 23 capable of detecting a state of the image forming device 1 is provided. Here, "detecting a state of the image forming device 1" in "a sensor 23 capable of detecting a state of the image forming device 1" means obtaining information useful for a subsequent recovery process of switching from the second control mode 212 to the first control mode 211.

Examples of the sensor 23 include a gyro sensor, an acceleration sensor, a thermometer, and an ink leak sensor. The gyro sensor or the acceleration sensor detects a change in a state of shaking due to an earthquake or the like as a state of the image forming device 1. The thermometer detects a change in the ambient temperature as a state of the image forming device 1. The leak sensor detects a presence state of liquid such as ink as a state of the image forming device 1.

When disaster information is an earthquake, the gyro sensor or the acceleration sensor detects that the shaking of the earthquake has subsided, and the state can be automatically returned to a state of the normal use. When disaster information is fire, it is possible to detect that the ambient temperature has decreased by the thermometer and automatically return to the state of the normal use. When disaster information is flood, it is possible to detect that the leak sensor is dry and automatically return to the state of the normal use.

The control section 21 is configured to switch from the second control mode 212 to the first control mode 211 based on a detection result of the sensor 23.

Here, "switch from the second control mode 212 to the first control mode 211" is used in a meaning including both switching in one step and switching in a plurality of steps.

### Description of operation of first embodiment

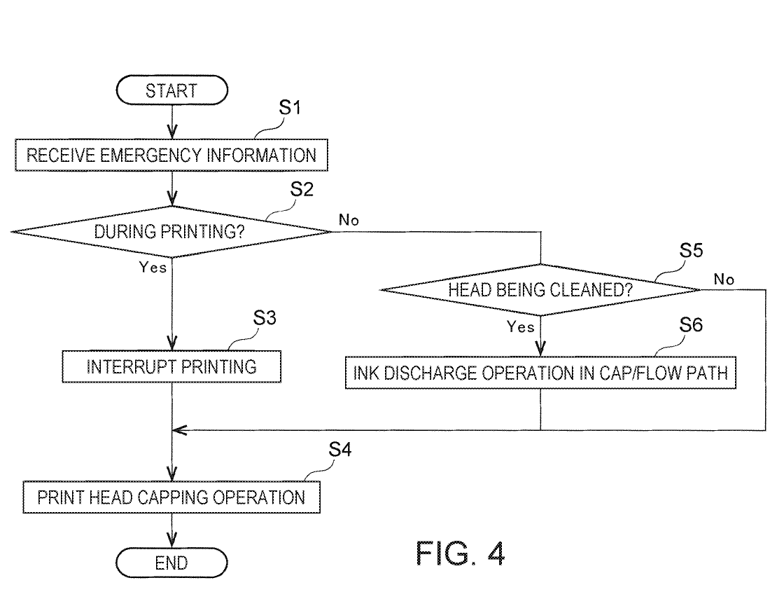

An operation of the first embodiment will be described with reference to FIG. 4.

When the reception section 20 receives emergency information that is information related to a disaster (step S1), the control section 21 switches from the first control mode 211 to the second control mode 212, and executes a control flow for an emergency in the second control mode 212.

First, it is determined in step S2 whether or not printing is currently being performed. If printing is in progress (Yes), the control flow proceeds to step S3, and printing is interrupted. Subsequently, the control flow proceeds to step S4, where the print head 16 is moved from the position illustrated in FIG. 2 to the position illustrated in FIG. 3. The cap 18 is further moved to cover the nozzle surface 17 of the head 16 (the state of FIG. 3), and the process is completed. That is, an operation for protecting the head 16 is executed, and the state is set in which evaporation of moisture from the nozzles 15 of the head 16 can be suppressed.

If printing is not being performed in step S2 (No), the control flow proceeds to step S5. When printing is not being performed, the head 16 is normally in a state of being covered by the cap 18. In step S5, it is determined whether or not the head 16 is being cleaned. If cleaning is being performed (Yes), the control flow proceeds to step S6, and ink in the cap 18 and a flow path (not illustrated) is discharged to the waste liquid accommodation section 19. The flow path is a flow path that communicates between the inside of the cap 18 and the inside of the waste liquid accommodation section 19. Then, the control flow proceeds to step S4, and a capping operation is continued. If cleaning is not being performed in step S5 (No), the control flow proceeds to step S4, and the capping operation is continued.

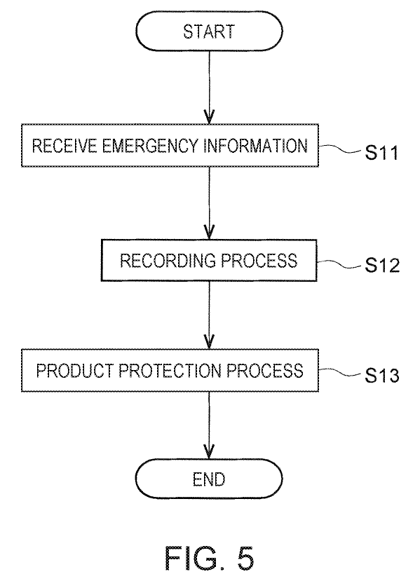

Further, in the present embodiment, the control section 21 is configured to execute a process illustrated in FIG. 5 before executing the control flow illustrated in FIG. 4.

That is, when the reception section 20 receives emergency information (step S11), the control flow proceeds to step S12, and a recording process is executed. Here, the recording process is a process of storing information received in step S11 and information related to one or more component sections such as the image forming section 6 in a storage section (not illustrated). Subsequently, the control flow proceeds to step S13, and the control flow illustrated in FIG. 4, which is a product protection process, is executed.

### Description of effects of first embodiment

(1) In the present embodiment, the control section 21 includes the first control mode 211 that causes one or more component sections, here, the image forming section 6, to execute on operation for normal use, and the second control mode 212 that executes an operation for protecting the one or more component sections. The control section 21 is configured to switch from the first control mode 211 to the second control mode 212 when the reception section 20 receives emergency information. By this, the component sections such as the image forming section 6 can be actively protected in addition to simply stopping a printing operation as in the related art.

(2) In the present embodiment, the head 16, which is capable of ejecting ink from the nozzles 15 toward the medium 7, and the cap 18, which covers the nozzle surface 17 of the head 16, are provided. The second control mode 212 is configured to execute an operation of covering the nozzle surface 17 with the cap 18. This makes it possible to suppress evaporation of moisture from the nozzles 15 of the head 16 that ejects ink, and to suppress occurrence of failure caused by the moisture evaporation. Therefore, a normal use state can be easily restored thereafter.

(3) In the present embodiment, the second control mode 212 is configured to discharge ink in the cap 18 to the waste liquid accommodation section 19 in a case where the nozzles 15 are being cleaned in a state where the nozzle surface 17 is covered with the cap 18. This can suppress ink leakage during cleaning.

(4) In the present embodiment, the second control mode 212 is configured to execute the recording process of the information and information related to the one or more component sections when emergency information is received. By this, the information at the time of disaster can be grasped in the subsequent recovery process, so that appropriate measures can be taken.

(5) In the present embodiment, the sensor 23 is provided that is capable of detecting at least one state of the image forming device 1, for example, shaking, the ambient temperature, ink leakage, and the like. The control section 21 is configured to switch from the second control mode 212 to the first control mode 211 based on a detection result of the sensor 23. By this, a subsequent recovery process of switching from the second control mode 212 to the first control mode 211 can be effectively performed.

(6) In the present embodiment, the determination section 24 that determines a shaking state of the image forming device 1 is provided. The control section 21 is configured to switch from the first control mode 211 to the second control mode 212 based on a determination result of the determination section 24. By this, if the collision is a mere collision, it is not necessary to protect the device, and therefore, it is possible to avoid an unnecessary protection operation.

### SECOND EMBODIMENT

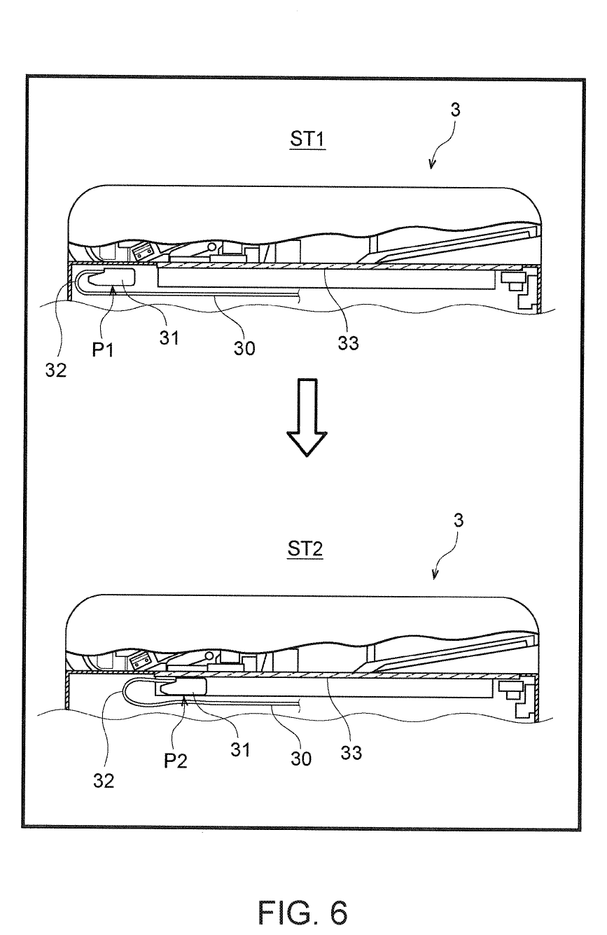

Next, the image forming device 1 according to a second embodiment will be described with reference to FIG. 6. The same portions as those in the first embodiment are denoted by the same reference symbols and the description of the configuration and the corresponding effects thereof will be omitted.

In the present embodiment, a movement section 31 is provided that reciprocates in a state of being connected to a flexible flat cable (FFC) 30. Here, the movement section 31 is a component section of the scanner 3, and is a reading section (for example, a CIS or CCD type sensor) that reads an image. The FFC 30 is connected to the movement section 31 in a state of including a U-shaped curved section 32. The movement section 31 is arranged below a glass plate 33. The movement section 31 reciprocates to read an image of the medium 7, that is, a document on the glass plate 33, and also the position of the U-shaped curved section 32 changes.

The movement section 31 includes, as stop positions, a first stop position P1 (state ST1 of FIG. 6) that is a stop position in the first control mode 211 and a second stop position P2 (state ST2 of FIG. 6) that is different from the first stop position P1. The second stop position P2 is a position where the degree of curvature of the U-shaped curved section 32 of the FFC 30 is looser than that at the first stop position P1. The second control mode 212 is configured to execute an operation of positioning the movement section 31 at the second stop position P2, that is, an operation for protecting the FFC 30 (state ST2 of FIG. 6).

The operation of positioning the movement section 31 at the second stop position P2, that is, an operation for protecting the FFC 30, is executed after step S4 in the control flow of FIG. 4.

In the present embodiment, the first stop position P1 is a position referred to as a home position of the movement section 31, that is, the reading section, in a state of normal use under the first control mode 211.

The second stop position P2 is a position referred to as a shipment position of the reading section. The shipment position is provided so that the U-shaped curved section 32 of the FFC 30 is not deformed during shipment, that is, so that deformation does not affect a subsequent reading operation of the reading section.

As described above, the FFC 30 is curved and inverted in a U-shape, and the degree of curvature of the U-shaped curved section 32 changes depending on a position of the movement section 31 during reciprocating movement. That is, there are a state where the degree of the U-shaped curvature is large and a state where the degree of the U-shaped curvature is small. When a U-shaped curved portion is left for a long time in a state where the degree of the U-shaped curvature is large, the U-shaped curved portion may be deformed.

In the present embodiment, the movement section 31 includes the first stop position P1, which is a stop position under the first control mode 211, and the second stop position P2, which is different from the first stop position P1. The second stop position P2 is a position where the degree of U-shaped curvature of the FFC 30 is looser than that at the first stop position P1. The second control mode 212 is configured to position the movement section 31 at the second stop position P2. This can suppress the occurrence of deformation in the U-shaped curved portion of the FFC 30. Accordingly, it is possible to suppress an adverse effect on a reciprocating operation of the movement section 31.

### THIRD EMBODIMENT

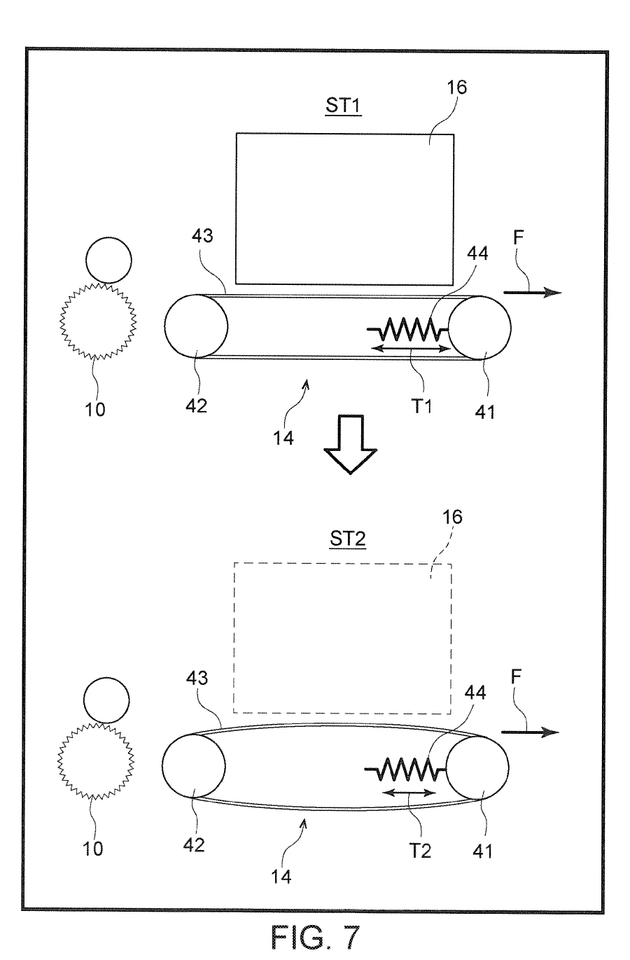

Next, the image forming device 1 according to a third embodiment will be described with reference to FIG. 7. The same portions as those in the first embodiment are denoted by the same reference symbols and the description of the configuration and the corresponding effects thereof will be omitted.

In the present embodiment, the belt unit 14 (component section) that transports the medium 7 includes a first roller 41, a second roller 42, and an endless belt 43 stretched between the first roller 41 and the second roller 42. The belt unit 14 includes a tension applying mechanism 44 that applies a tension to the endless belt 43.

The tension applying mechanism 44 can switch between and apply a first tension T1 (state ST1 of FIG. 7), which is the tension under the first control mode 211, and a second tension T2 (state ST2 of FIG. 7), which is a tension smaller than the first tension T1. The second control mode 212 is configured to apply the second tension T2 to the endless belt 43, that is, to execute an operation for protecting the endless belt 43.

An operation of applying the second tension T2 to the endless belt 43, that is, the operation for protecting the endless belt 43, is executed after step S4 in the control flow of FIG. 4.

The belt unit 14 is prevented from being deformed by releasing tension during shipment as in a case of the FFC 30. In the present embodiment, the second tension T2 is set to the same magnitude as a tension during shipment.

Since the endless belt 43 is stretched between the first roller 41and the second roller 42, when the endless belt 43 is left for a long time in a state where the first tension T1 is applied, a portion in contact with the first roller 41 and a portion in contact with the second roller 42 may become deformed.

In the present embodiment, the tension applying mechanism 44 can switch between and apply the first tension T1 under the first control mode 211 and the second tension T2, which is a tension smaller than the first tension T1. The second control mode 212 is configured to apply the second tension T2 to the endless belt 43. This makes it possible to suppress the occurrence of deformation of the endless belt 43. Accordingly, it is possible to suppress a decrease in the transport accuracy of the medium 7 due to the deformation.

### FOURTH EMBODIMENT

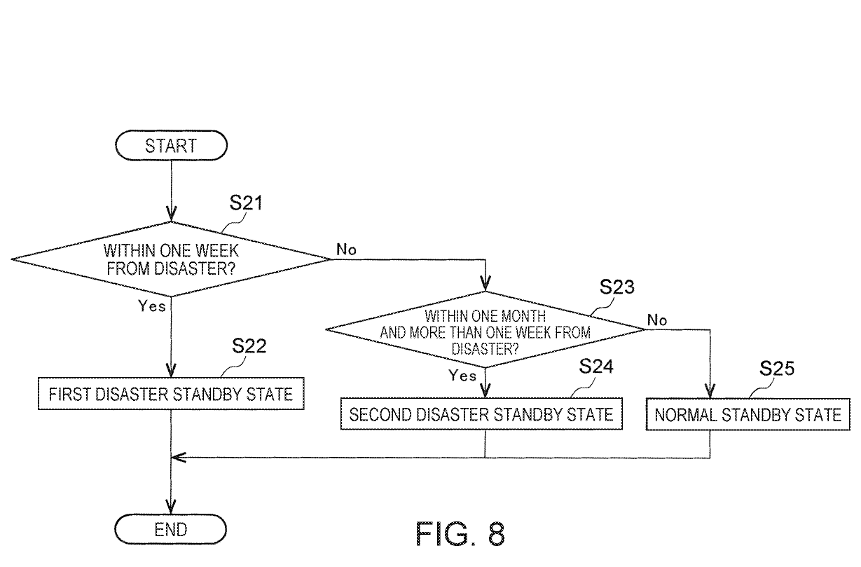

Next, the image forming device 1 according to a fourth embodiment will be described with reference to FIG. 8. The same portions as those in the first embodiment are denoted by the same reference symbols and the description of the configuration and the corresponding effects thereof will be omitted.

In the present embodiment, the control section 21 can change an operating state for protecting a component section such as the head 16 in accordance with the elapsed time from when the reception section 20 receives the information.

FIG. 8 illustrates a control flow of the control section 21 in a standby state after the reception section 20 receives emergency information. The standby state is changed in accordance with the lapse of time from the occurrence of disaster. The standby state also has a level, and immediately after the occurrence of disaster, a first disaster standby state is set as a protection state in which a product is the most difficult to break. After a while from the occurrence of the disaster, a second disaster standby state in which only the head 16 can be protected is set. The level of the disaster standby state and the elapsed time can be set arbitrarily depending on the product, and may be set in any number of steps.

The control section 21 determines whether or not the elapsed time from when the reception section 20 received emergency information, which is information related to disasters, is within one week at step S21. The elapsed time within one week is an example. If the answer is Yes in step S21, the control flow proceeds to step S22, and the first disaster standby state is set. The first disaster standby state is a protection state against a state in which a product immediately after the occurrence of disaster is most likely to be broken.

If the answer in step S21 is No, the control flow proceeds to step S23, and in step S23, it is determined whether the elapsed time from the occurrence of the disaster is within one month and more than one week. The elapsed time is also an example. If the answer is Yes in step S23, the control flow proceeds to step S24 to set the second disaster standby state. In the second disaster standby state, for example, only the head 16 is set to a protection state, and the movement section 31 connected to the FFC 30 and the endless belt 43, which are other component sections, are returned to a state of normal use.

If the answer is No in step S23, the control flow proceeds to step S25 to set a normal standby state. The normal standby state is a state of normal use.

Immediately after the occurrence of a disaster, the necessity of protection for component sections such as the head 16 is high as described above. However, the degree of necessity of the protection changes with the lapse of time.

In the present embodiment, the control section 21 can change an operating state for protecting a component section such as the head 16 in accordance with the elapsed time from when the reception section 20 receives the information. This makes it possible to implement protection in accordance with a change in situation with the lapse of time of disaster occurrence.

### OTHER EMBODIMENTS

The image forming device 1 according to the present disclosure basically includes the configuration of the embodiments described above, but it is of course possible to change or omit partial configuration within a range not departing from the gist of the present disclosure.

(1) First, in the above-described embodiments, the image forming section 6 is described as a line head, but may be a serial type head that reciprocates. Since the serial type head is connected to an FFC, it is desirable to include a structure including the first stop position P1 and the second stop position P2 as in the second embodiment.

(2) In the above-described embodiments, shipment positions of the movement section 31 and the endless belt 43 are used, but it goes without saying that the present disclosure is not limited to using shipment positions. For example, although a sheet feed unit does not include a shipment position, a load applied to a sheet feed roller may be deformed due to long-term non-use. In the second control mode 212, it is desirable to reduce the load applied to the sheet feed roller so as to prevent the sheet feed roller from deforming.

What is claimed is:

1. An image forming device comprising:
a reception section that receives information related to disasters;
an image forming section that executes an image forming process on a medium; and
a control section, wherein
the control section includes
a first control mode that causes one or more component sections to execute an operation for normal use and
a second control mode that executes an operation for protecting the one or more component sections and
the control section switches from the first control mode to the second control mode when the reception section receives the information.

2. The image forming device according to claim 1, wherein
the image forming section includes
a head configured to eject ink from a nozzle toward the medium and
a cap that covers a nozzle surface of the head and
in the second control mode, an operation of covering the nozzle surface with the cap is executed.

3. The image forming device according to claim 2, further comprising:
a waste liquid accommodation section that receives and accommodates ink in the cap, wherein
in the second control mode, in a case where the nozzle is being cleaned in a state where the nozzle surface is covered with the cap, the ink in the cap is discharged to the waste liquid accommodation section.

4. The image forming device according to claim 1, further comprising:
a movement section that reciprocates in a state of being connected to an FFC, wherein
the movement section includes
a first stop position that is a stop position in the first control mode and
a second stop position that is different from the first stop position,
the second stop position is a position where a degree of U-shaped curvature of the FFC is looser than that at the first stop position, and
in the second control mode, the movement section is positioned at the second stop position.

5. The image forming device according to claim 1, further comprising:
a belt unit that transports the medium, wherein
the belt unit includes a first roller, a second roller, and an endless belt stretched between the first roller and the second roller,
the image forming device further includes a tension applying mechanism that applies a tension to the endless belt,
the tension applying mechanism is configured to switch between and apply a first tension that is a tension under the first control mode and a second tension that is a tension smaller than the first tension, and
in the second control mode, the second tension is applied to the endless belt.

6. The image forming device according to claim 1, wherein
in the second control mode, when the information is received, a recording process of the information and information related to the one or more component sections is executed.

7. The image forming device according to claim 1, wherein
the control section is configured to change an operating state for protecting the component section in accordance with an elapsed time from when the reception section receives the information.

8. The image forming device according to claim 1, further comprising:
a sensor configured to detect a state of the image forming device, wherein
the control section switches from the second control mode to the first control mode based on a detection result of the sensor.

9. The image forming device according to claim 1, further comprising:
a determination section that determines a shaking state of the image forming device, wherein
the control section switches from the first control mode to the second control mode based on a determination result of the determination section.
